(19) United States
(12) Patent Application Publication
(10) Pub. No.: US 2002/0162990 A1
(43) Pub. Date: Nov. 7, 2002

(54) Composition and process for etching and desmutting aluminum and its alloys

(75) Inventors: Philip M. Johnson, Southfield, MI (US); Kelly R. Sakorafos, Sterling Heights, MI (US); Lawrence R. Carlson, Oxford, MI (US)

Correspondence Address: Michael S. Brodbine, Brooks & Kushman P.C., 22nd Floor, 1000 Town Center, Southfield, MI, 48075-1351, US

(73) Assignee: Henkel Corporation, Gulph Mills, PA

(21) Appl. No.: 10/072,745

(22) Filed: Feb. 7, 2002

Related U.S. Application Data
(60) Provisional application No. 60/267,540, filed on Feb. 9, 2001.

(51) Int. Cl. C02F 5/02

(52) U.S. Cl. 252/175

(57) ABSTRACT

The present invention comprises a one-step method of etching and desmutting aluminum and its alloys. The method comprises exposing articles made of aluminum and its alloys to a liquid etching/desmutting composition. The liquid composition comprises water and an acid source comprising sulfuric acid and nitric acid, a non-fluorine etchant source comprising phosphoric acid, and a stabilized oxidant. A particularly preferred liquid composition suitable for the etching and simultaneous desmutting of aluminum and aluminum alloys, comprises water and diluted sulphuric acid, nitric acid, phosphoric acid, molybdate and/or condensed molybdate ions, a perfluoroalkyl sulfonate, and aluminum sulfate.

### CROSS-REFERENCE TO RELATED APPLICATIONS

This application claims the benefit of U.S. provisional application Serial No. 60/267,540 filed Feb. 9, 2001.

### BACKGROUND OF THE INVENTION

1. Field of the Invention

This invention relates to compositions and processes that enable surfaces of aluminum and its alloys to be etched without requiring a subsequent “desmutting” step. The invention is particularly useful with copper and zinc containing aluminum alloys that are typically used in forming parts suitable for the aerospace industry, such as airplane components.

2. Background Art

Chemical and mechanical treatments of aluminum and its alloys often leave the surface with a dark coating that must be removed before subsequent surface finishing steps can be satisfactorily completed. This process is generally known in the art as “desmutting” or sometimes as “deoxidizing.” The dark coating requiring desmutting comprises residual intermetallic aluminum alloying agents; such as copper, zinc, silicon and iron, that remain on the surface of etched aluminum or aluminum alloy. The conventional desmutting compositions have normally included concentrated nitric and/or sulfuric acid and chromates, with fluorides, ferric ions, oxidizers such as persulfate and peroxide, and ferricyanide all serving as frequently used optional ingredients. In recent years there has been environmentally driven incentive to avoid the use of chromates and ferricyanides, but no fully satisfactory deoxidizer free from these materials is believed to have been developed. Accordingly, it would be desirable to provide a composition and process that could etch aluminum and its alloys without requiring a subsequent desmutting step.

### SUMMARY OF THE INVENTION

It has been found that certain acidic etchant compositions containing sulfuric acid, nitric acid, phosphoric acid, and a stabilized oxidant will essentially simultaneously etch and desmut surfaces of aluminum and its alloys. Notably, triethanolamine and sodium sulfide, components that are typically present in prior art alkaline etchant compositions, are not present in the acidic etchant of the present invention. Also, the acidic etchant composition of the present invention eliminates the need for a subsequent desmutting step and thus the use of chromium, iron, and fluorine components that are typically found in desmutting compositions. Thus, the etching and desmutting of aluminum alloys may be done in one processing step in lieu of the two-step alkaline etching and desmutting process.

### DESCRIPTION OF THE PREFERRED EMBODIMENTS

Embodiments of the present invention comprise a method and an acidic aqueous composition for etching and simultaneously desmutting of aluminum and its alloys, wherein the aqueous composition comprises, preferably consists essentially of, and more preferably consists of, water and:

(A) an acid source comprising sulfuric acid and nitric acid;

(B) a non-fluorine containing etchant source comprising phosphoric acid; and

(C) a stabilized oxidant; and optionally one or more of the following:

(D) a wetting agent and/or a degassing agent; and

(E) a complexing agent and/or a grain modifier.

In a preferred embodiment, the composition comprises water and:

(1) diluted sulphuric acid;

(2) nitric acid;

(3) phosphoric acid;

(4) molybdate and/or condensed molybdate ions;

(5) a perfluoroalkyl sulfonate; and

(6) aluminum sulfate.

Various embodiments of the invention include working compositions for direct use in treating metals, concentrates and partial concentrates from which such working compositions can be prepared by dilution with water and/or mixing with other chemically distinct concentrates, processes for treating metals with a composition according to the invention, and extended processes including additional steps that are conventional per se, such as rinsing, and, particularly advantageously, subsequent conversion coating, anodizing, fusion welding, penetrant dyeing and/or painting or some similar overcoating process that puts into place an organic binder containing protective coating over the metal surface treated according to a narrower embodiment of the invention. Articles of manufacture including surfaces treated according to a process of the invention are also within the scope of the invention.

For a variety of reasons, it is preferred that compositions according to the invention, as defined above, should be substantially free from many ingredients used in compositions for similar purposes in the prior art. Specifically, it is increasingly preferred in the order given, independently for each preferably minimized component listed below, that these compositions, when directly contacted with metal in a process according to this invention, contain no more than 1.0, 0.35, 0.10, 0.08, 0.04, 0.02, 0.01, 0.001, or 0.0002, percent of each of the following constituents: hexavalent chromium; iron compounds; silica; silicates that do not contain at least four atoms of fluorine per atom of silicon (fluoroalkyl silicon compounds); ferricyanide; ferrocyanide; thiourea; sugars; glycerine; α-glucoheptanoic acid and its salts; and salts thereof.

The components in the preferred composition are preferably, more preferably, and most preferably present in the following weight percents, based on total weight of the compositions:

| | Preferred Range | More Preferred | Most Preferred |
|---|---|---|---|
| Component | (wt. %) | Range (wt. %) | Range (wt. %) |
| 1 | 10-50 | 12-35 | 18-25 |
| 2 | 0.5-15 | 1-10 | 2.5-7.5 |
| 3 | 25-90 | 35-85 | 45-70 |
| 4 | 0.01-2 | 0.01-0.75 | .05-.25 |
| 5 | 0-0.1 | 0.0001-0.01 | .0005-.005 |
| 6 | 0-10 | 0.5-5 | 1-3 |
| Water | 5-50 | 10-35 | 16-20 |

The acid source (A) comprises acids that are capable of holding ions of aluminum intermetallic alloying elements (copper, zinc, silicon, and iron) in solution. The acid source (A) preferably comprises sulfuric acid (1) and nitric acid (2).

Preferably, but not necessarily, the sulfuric acid (1) comprises diluted sulfuric acid. By diluted sulfuric acid, it is meant an aqueous solution of sulfuric acid containing less than 80 wt. % (water comprising the other 20%), most preferably 55 wt. % sulfuric acid, based on the total weight of the aqueous sulfuric acid solution. Most preferably, the sulfuric acid (1) comprises Base 443, a pre-reacted/diluted roughly 45% by weight sulfuric acid solution used by Henkel that comprises a 50% solution of Sulfuric Acid 66° Baume, a 93% sulfuric acid solution available from Ashland Chemical Company of Boonton, N.J.

Preferably, but not necessarily, the nitric acid (2) comprises concentrated nitric acid. By concentrated nitric acid, it is meant an aqueous solution of nitric acid containing 45 to 75 wt. % nitric acid, more preferably 64 to 70 wt. % nitric acid, and most preferably 66 to 68 wt. % nitric acid, based on the total weight of the aqueous nitric acid solution. A preferred nitric acid (2) comprises nitric acid 42°, a commercial grade nitric acid (a 67% by weight solution) having a specific gravity of 42° Baume available from Dupont of Wilmington, Del.

The etchant source (B) comprises a compound that primarily functions to remove ionized aluminum metal at a given rate in lieu of fluorine. The etchant source (B) preferably comprises phosphoric acid (3). Preferably, but not necessarily, the phosphoric acid (3) comprises diluted phosphoric acid. By diluted phosphoric acid, it is meant an aqueous solution of phosphoric acid containing less than 95 wt. %, and most preferably 75 wt. % phosphoric acid. The most preferred etchant source (B) comprises Phosphoric Acid 75%, by weight, aqueous solution of phosphoric acid available from Quadra Corporation of Huntersville, N.C.

The stabilized oxidant (C) comprises one or more compounds that primarily function to oxidize and ionize ground state metals, such as copper, zinc, silicon, and iron, that are present in aluminum alloys to the divalent transition state to create in-situ acid metal salts that are then able to be solubilized by the etchant source (B). The stabilized oxidant (C) helps to minimize the generation of NO_{X}. The stabilized oxidant (C) can be either inorganic or organic, and preferably comprises molybdate and/or condensed molybdate ions (4). Because the degree of aggregation of molybdate ions is usually uncertain and is not believed to affect the favorable action of molybdate ions in compositions according to this invention, the concentration of these ions is described herein as the stoichiometric equivalent as molybdenum atoms, even though only those molybdenum atoms that are present in some form of molybdate or condensed molybdate anions are believed to be effective. A preferred stabilized oxidant (C) comprises Ammonium Molybdate available from Climax Molybdenum Company (Division of Cyprus Climax Metals) of Tempe, Ariz.

For component (D), almost any surfactant or wetting agent that is effective to lower the surface tension and solubilize any organic contaminants present on the surface to be treated could be used in principle.

Surfactants which have been found to be satisfactorily stable, adequate in reducing surface tensions of the compositions while not making them intolerably prone to foaming, and effective in keeping dried areas from forming during transfer times up to at least 3 minutes between treatment and rinsing, and which are therefore particularly preferred, are alkyl carboxyl derivatives and perfluoroakyl sulfonates with amphoteric mixes.

Component (D) can also comprise any suitable degassing agent known in the art that is capable of changing the size and/or structures of the foaming bubbles which operates to retard and/or prevent the formation of noxious gases such as NO_{X}, SO_{X}, to name a few.

Component (D) may comprise one compound that operates both as a wetting agent and a degassing agent, or one or more compounds that operate independently as a wetting agent or a degassing agent.

A particularly preferred Component (D) comprises the oxidant stable surfactant Zonyl FSN-100, a perfluoroalkyl sulfonate (5), available from DuPont. Zonyl FSN-100 operates both as a wetting agent and a degassing agent.

Component (E) may comprise any suitable complexing agent/grain modifier that is known in the art. A particularly preferred Component (E) comprises aluminum sulfate (6) available from General Alum and Chemical Corporation of Holland, Ohio, under the name Aluminum Sulfate, LQ.

One preferred method of making a preferred composition of the present invention comprises adding water to a mixing tank, and preferably a stainless steel or acid-resistant plastic mixing tank, and turning on the agitator. Then the pre-diluted sulfuric acid (1) is added to the tank. Next, the molybdate (4) is sifted in and mixed until dissolved. The remaining ingredients (2), (3), (5) and (6) are then mixed in until a uniform composition results.

A working composition according to the invention may be applied to a metal surface to be treated by any convenient method, several of which will be readily apparent to those skilled in the art. Immersion is the simplest and is believed most often used. However, spraying, roll coating, and the like can also be used.

The temperature during contact and time of contact between the composition according to the invention and the metal to be treated thereby may be varied within wide limits to achieve the desired effects, which can often be determined by visual inspection of the metal surface, after rinsing if necessary. As a general guideline, the temperature normally preferably is, with increasing preference in the order given, not less than 20° C. or 30° C. and independently preferably is, with increasing preference in the order given, not more than 80° C. or 60° C., and the time of contact normally preferably is, with increasing preference in the order given, not less than 0.1, 0.5, 1.0, 1.5, 1.8, or 2.0 minutes and independently preferably is, with increasing preference in the order given, not more than 180, 120, 60, or 30 minutes.

After treatment according to this invention, the treated surfaces are normally rinsed with water before any subsequent treatment. Preferably, the rinsing is completed as soon as practical after removing the treated surfaces from contact with the etchant composition, and if at all practicable should at least be completed before the etchant composition has dried into place on any part of the surface. After rinsing the surfaces often are also dried. Rinsing, drying, and any subsequent treatments are generally performed using suitable manners known in the art.

Preferably, the invention is used in connection with wrought aluminum alloys containing copper and zinc. The invention is particularly advantageously adapted to the treatment of aluminum alloys 7150, 7075, 2024, 2324, and 6061.

During extended use of the etchant composition according to this invention, new constituents may be introduced into the etchant composition by dissolution of the metal objects treated, and some of the constituents of the bath may be consumed by reaction. Therefore, as with other similar treatments, if very long term operation is desired, it is advantageous to withdraw a portion of the composition continuously for removal of any unwanted constituents and to replenish depleted desirable constituents. In some cases, only replenishment may be satisfactory, or no treatment of the composition at all may be required.

The practice of this invention may be further appreciated by consideration of the following, non-limiting, working example.

### EXAMPLE

| | Parts/Weight | | |
|---|---|---|---|
| | (lbs) | | Component |
| | 172.4900 | | WATER TAP |
| | 200.0000 | | BASE 443 |
| | 1.5000 | | AMMONIUM MOLYBDATE |
| | 560.0000 | | PHOSPHORIC ACID 75% |
| | 50.0000 | | NITRIC ACID 42° |
| | 16.0000 | | ALUMINUM SULFATE, LQ, TECH GRD |
| | .0100 | | ZONYL FSN-100 |
| Totals: | 1000.0000 | lbs. | |

The above working composition was prepared by adding the water to a mixing tank, preferably a stainless steel or acid-resistant plastic tank, and turning on the agitator, following which Base 443 is added to the tank. The ammonium molybdate is then sifted in and the mixture agitated until the ammonium molybdate is dissolved. Next, the phosphoric acid, nitric acid, aluminum sulfate and Zonyl FSN-100 (which has been heated to between 100°-120° F. to liquify) are added and agitated for 30 minutes or until the Zonyl FSN-100 has dissolved.

Parts made of the aluminum alloys 2024-T3 and 7075-T6 were then exposed to the above working composition for 15 minutes. The parts were observed to be etched and +desmutted.

Except where otherwise expressly indicated, all numerical quantities indicating amounts of material or conditions of reaction and/or use herein are to be understood as modified by the word “about” in describing the broadest scope of the invention. Practice within the numerical limits stated is generally preferred. Also, unless expressly stated to the contrary: percent, “parts of”, and ratio values are by weight based on total weight of the composition of solutions; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; specification of materials in ionic form implies the presence of sufficient counterions to produce electrical neutrality for the composition as a whole, and any counterions thus implicitly specified should preferably be selected from among other constituents explicitly specified in ionic form, to the extent possible; otherwise such counterions may be freely selected, except for avoiding counterions that act adversely to the objects of the invention; the term “mole” means “gram mole”, and “mole” and its variations may be applied herein to ionic or any other chemical species with defined numbers and types of atoms, as well as to chemical substances with well defined conventional molecules.

While embodiments of this invention have been illustrated and described, it is not intended that these embodiments illustrate or describe all possible forms of the invention. Rather, the words used in the specification are words of description rather than limitation, and it is understood that various changes may be made without departing from the spirit and scope of the invention.

What is claimed is:

1. A liquid composition suitable for the etching and simultaneous desmutting of aluminum and aluminum alloys, comprising water and:
(A) an acid source comprising sulfuric acid and nitric acid; and
(B) a non-fluorine containing etchant source comprising phosphoric acid; and
(C) a stabilized oxidant comprising one or more compounds that are capable of oxidizing and/or ionizing ground state metals.

2. The liquid composition of claim 1, wherein the (C) stabilized oxidant comprises molybdate and/or condensed molybdate ions.

3. The liquid composition of claim 1, wherein the liquid composition further comprises (D) a wetting agent and/or a degassing agent.

4. The liquid composition of claim 1, wherein the liquid composition further comprises (E) a complexing agent and/or a grain modifier.

5. The liquid composition of claim 3, wherein the liquid composition further comprises (E) a complexing agent and/or a grain modifier.

6. The liquid composition of claim 1, wherein the sulphuric acid is present in an amount of 10 to 50 weight percent, based on the total weight of the liquid composition, the nitric acid is present in an amount of 0.5 to 15 weight percent, based on the total weight of the liquid composition, the phosphoric acid is present in an amount of 25 to 90 weight percent, based on the total weight of the liquid composition, and the stabilized oxident is present in an amount less than 2 weight percent, based on the total weight of the liquid composition.

7. The liquid composition of claim 2, wherein the sulphuric acid is present in an amount of 10 to 50 weight percent, based on the total weight of the liquid composition, the nitric acid is present in an amount of 0.5 to 15 weight percent, based on the total weight of the liquid composition, the phosphoric acid is present in an amount of 25 to 90 weight percent, based on the total weight of the liquid composition, and the stabilized oxidant is present in an amount less than 2 weight percent, based on the total weight of the liquid composition.

8. The liquid composition of claim 6, wherein the sulphuric acid is present in an amount of 12 to 35 weight percent, based on the total weight of the liquid composition, the nitric acid is present in an amount of 1 to 10 weight percent, based on the total weight of the liquid composition, the phosphoric acid is present in an amount of 35 to 85 weight percent, based on the total weight of the liquid composition, and the stabilized oxident is present in an amount of 0.01 to 0.75 weight percent, based on the total weight of the liquid composition.

9. The liquid composition of claim 8, wherein the sulphuric acid is present in an amount of 18 to 25 weight percent, based on the total weight of the liquid composition, the nitric acid is present in an amount of 2.5 to 7.5 weight percent, based on the total weight of the liquid composition, the phosphoric acid is present in an amount of 45 to 70 weight percent, based on the total weight of the liquid composition, and the stabilized oxident is present in an amount of 0.05 to 0.25 weight percent, based on the total weight of the liquid composition.

10. The liquid composition of claim 5, wherein component (D) is present in an amount less than 0.1 weight percent, based on the total weight of the liquid composition.

11. The liquid composition of claim 5, wherein the component (E) is present in an amount of less than 10 weight percent, based on the total weight of the liquid composition.

12. The liquid composition of claim 11, wherein the water is present in an amount of 5 to 50 weight percent, based on the total weight of the liquid composition.

13. The liquid composition of claim 1, wherein the liquid composition comprises water and:
(1) diluted sulphuric acid;
(2) nitric acid;
(3) phosphoric acid;
(4) molybdate and/or condensed molybdate ions;
(5) a perfluoroalkyl sulfonate; and
(6) aluminum sulfate.

14. The liquid composition of claim 13, wherein the diluted sulphuric acid comprises an aqueous solution of sulphuric acid containing less than 80 weight percent sulphuric acid, based on the total weight of the aqueous sulphuric acid solution, with the diluted sulphuric acid being present in the liquid composition in an amount of 10 to 50 weight percent, based on the total weight of the liquid composition, wherein the nitric acid comprises an aqueous nitric acid solution containing nitric acid in an amount between 45 and 75 weight percent, based on the total weight percent of the nitric acid solution, with the nitric acid solution being present in the liquid composition in an amount of between 0.5 and 15 weight percent, based on the total weight of the liquid composition, wherein the phosphoric acid comprises an aqueous phosphoric solution containing the phosphoric acid in an amount less than 95% weight percent, based on the total weight of the aqueous phosphoric acid solution, with the phosphoric acid solution being present in the liquid composition in an amount of between 25 to 90 weight percent, based on the total weight of the liquid composition, wherein the component (4) is present in the liquid composition in an amount of less than 2 weight percent, based on the total weight of the liquid composition, wherein the perfluoroalkyl sulfonate is present in the liquid composition in an amount of less than 0.1 weight percent, based on the total weight of the liquid composition, wherein the aluminum sulfate is present in the liquid composition in an amount of less than 10 weight percent, based on the total weight of the liquid composition, and wherein the water is present in the liquid composition in an amount of between 5 and 50 weight percent, based on the total weight of the liquid composition.

15. The liquid composition of claim 13, wherein the liquid composition consists essentially of water and;
(1) diluted sulphuric acid;
(2) nitric acid;
(3) phosphoric acid;
(4) molybdate and/or condensed molybdate ions;
(5) a perfluoroalkyl sulfonate; and
(6) aluminum sulfate.

16. A method of etching and desmutting aluminum and its alloys, said method comprising:
exposing articles made of aluminum and its alloys to the liquid etching/desmutting composition of claim 1.

17. The method of claim 16, wherein the liquid composition comprises water and:
(A) an acid source comprising sulfuric acid and nitric acid;
(B) a non-fluorine etchant source comprising phosphoric acid; and
(C) a stabilized oxidant; and optionally one or more of the following:
(D) a wetting agent and/or a degassing agent; and
(E) a complexing agent and/or a grain modifier.

18. The method of claim 16, wherein the liquid composition comprises water and:
(1) diluted sulphuric acid;
(2) nitric acid;
(3) phosphoric acid;
(4) molybdate and/or condensed molybdate ions;
(5) a perfluoroalkyl sulfonate; and
(6) aluminum sulfate.

19. The method of claim 18, wherein the liquid composition is made by adding the water to a mixing tank, agitating the water, then adding the diluted sulphuric acid to the mixing tank, then sifting in the molybdate (4) and mixing until dissolved, then mixing in the nitric acid, the phosphoric acid, the perfluoroalkyl sulfonate, and the aluminum sulfate until a uniform composition results.

20. The method of claim 18, wherein the method further comprises rinsing the article with water after exposing the article to the liquid composition.

21. A liquid composition suitable for the etching and simultaneous desmutting of aluminum and aluminum alloys, comprising water and:
(1) diluted sulphuric acid;
(2) nitric acid;
(3) phosphoric acid; and
(4) molybdate and/or condensed molybdate ions.
